(19) United States
(12) Patent Application Publication
(10) Pub. No.: US 2008/0280068 A1
(43) Pub. Date: Nov. 13, 2008

(54) Apparatus and Method for Manufacturing Ultra-Fine Particles

(75) Inventor: Kang-Ho Ahn, Seoul (KR)

Correspondence Address: LOWE HAUPTMAN HAM & BERNER, LLP, 1700 DIAGONAL ROAD, SUITE 300, ALEXANDRIA, VA, 22314, US

(73) Assignee: KANG-HO AHN, SEOUL (KR)

(21) Appl. No.: 11/908,663

(22) PCT Filed: Mar. 14, 2006
(86) PCT No.: PCT/KR2006/000911

§ 371 Date: Jul. 15, 2008

(30) Foreign Application Priority Data
Mar. 17, 2005 (KR) 10-2005-0022178

(51) Int. Cl. B05D 1/00; B01J 19/12; B01J 19/08

(52) U.S. Cl. 427/580; 422/186; 422/186.04; 204/157.15

(57) ABSTRACT

An ultra-fine particle manufacturing apparatus and method is capable of producing nanometer-sized ultra-fine particles from reaction gases with high energy light beams, corona discharge and an electric field. High energy light beams are irradiated into a chamber of a housing through the use of a high energy light source. Reaction gases are supplied from a reaction gas supply device to a reaction gas inlet tube. The reaction gases are then introduced through the reaction gas inlet tube into the chamber of the housing to produce a large quantity of ultra-fine particles through the reaction of the reaction gases with the high energy light beams. A voltage is applied to the reaction gas inlet tube by means of a power supply device. The ultra-fine particles flowing within the chamber of the housing are collected by means of a collecting plate.

### FIELD OF THE INVENTION

The present invention is directed to an apparatus and method for manufacturing ultra-fine particles and, more specifically, to an apparatus and method for producing ultra-fine particles of a nanometer size from reaction gases through irradiation of high energy light beams, corona discharge and formation of electric fields.

### BACKGROUND ART

In general, ultra-fine particles of a nanometer size are produced through the use of a flame or within a furnace and then collected by means of a filter or a collecting plate. Such a conventional method has drawbacks in that a great deal of energy is consumed in the process of producing the ultra-fine particles at an elevated temperature and further that the ultra-fine particles are collected at a reduced efficiency. Another shortcoming is that the environment may be polluted by non-collected ultra-fine particles of metal oxide such as SiO₂, Fe₂O₃ or the like. The conventional method presents a further problem in that the ultra-fine particles are adhered to one another into a lump, thus loosing its intrinsic characteristics.

Another known method of producing ultra-fine particles is a corona discharge, one kind of in-gas discharges, characterized by a phenomenon that, if a high voltage is developed between two electrodes, the portion of an electric field with high intensity emits light prior to the generation of a spark and hence becomes electrically conductive. The electric field is uniformly created in a case that the electrodes are all comprised of a plate or a sphere having an increased diameter. If one or both of the electrodes is of a needle type or a cylinder type, the portion of electric field adjacent to that electrode becomes more intensive than elsewhere, whereby a partial discharge is brought on. Electrons discharged in the corona discharge process are collided with molecules of the surrounding air, thus generating a large quantity of positively charged ions. The gases kept divided by the electrons and the positive ions are referred to as plasma.

The plasma technology to which the corona discharge belongs is extensively used in dry etching, chemical vapor deposition (CVD), plasma polymerization, surface modification, sputtering, air purification and other applications, as disclosed in U.S. Pat. Nos. 5,015,845, 5,247,842, 5,523,566 and 5,873,523.

### DETAILED DESCRIPTION OF THE INVENTION

### Technical Problems

However, the above-noted and other prior art plasma technologies pose a problem in that the apparatus used becomes structurally complicated by the adoption of a needle type or cylinder type electrode. In particular, the needle type electrode is apt to be degraded and severed when in use for a prolonged period of time. Replacing the severed electrode with a new one reduces workability and operability. Furthermore, the corona discharge has a limit in increasing the yield rate of ultra-fine particles.

In view of the above-noted problems inherent in the prior art, it is an object of the present invention to provide an apparatus and method capable of producing, with an increased yield rate, ultra-fine particles of a nanometer size from reaction gases through irradiation of high energy light beams, corona discharge and formation of electric fields.

Another object of the present invention is to provide an apparatus and method that can collect ultra-fine particles with enhanced efficiency.

A further object of the present invention is to provide an apparatus and method that can have different kinds of ultra-fine particles bonded together and can efficiently coat one ultra-fine particle on the other.

### Solution to the Technical Problems

With these objects in mind, one aspect of the present invention is directed to an ultra-fine particle manufacturing apparatus comprising: a housing having a chamber and an optical window provided at one side of the chamber; a reaction gas supply means provided outside the housing for supplying reaction gases to the chamber; at least one reaction gas inlet tube mounted on an upstream side of the housing and connected to the reaction gas supply means for introducing the reaction gases into the chamber; a gas outlet tube mounted on a downstream side of the housing for discharging non-reacted gases; a high energy light source provided for irradiating high energy light beams on the reaction gases introduced into the chamber through the optical window of the housing to produce a large quantity of ultra-fine particles; a collecting means grounded and disposed at a downstream side within the chamber for collecting the ultra-fine particles; and a power supply means connected to the reaction gas inlet tube for applying a voltage to the reaction gas inlet tube.

Another aspect of the present invention is directed to an ultra-fine particle manufacturing method comprising the steps of: irradiating high energy light beams into a chamber of a housing through the use of a high energy light source; supplying reaction gases from a reaction gas supply means to a reaction gas inlet tube; introducing the reaction gases through the reaction gas inlet tube into the chamber of the housing to produce a large quantity of ultra-fine particles through the reaction of the reaction gases with the high energy light beams; applying a voltage to the reaction gas inlet tube by means of a power supply means; and collecting the ultra-fine particles flowing within the chamber of the housing by means of a collecting means.

### BRIEF DESCRIPTION OF THE DRAWINGS

FIG. 1 is a cross-sectional view showing an ultra-fine particle manufacturing apparatus in accordance with the first embodiment of the present invention;

FIG. 2 is a graph representing the distribution of size of the ultra-fine particles produced by the ultra-fine particle manufacturing apparatus in accordance with the first embodiment of the present invention;

FIG. 3 is a flow chart for explaining an ultra-fine particle manufacturing method in accordance with the first embodiment of the present invention;

FIG. 4 is a cross-sectional view showing an ultra-fine particle manufacturing apparatus in accordance with the second embodiment of the present invention;

FIGS. 5 through 10 are views illustrating waveforms of a high voltage applied to a reaction gas inlet tube by means of a power supply device in the ultra-fine particle manufacturing apparatus in accordance with the second embodiment of the present invention;

FIG. 11 is a cross-sectional view showing an ultra-fine particle manufacturing apparatus in accordance with the third embodiment of the present invention;

FIG. 12 is a cross-sectional view showing an ultra-fine particle manufacturing apparatus in accordance with the fourth embodiment of the present invention;

FIG. 13 is a flow chart for explaining an ultra-fine particle manufacturing method in accordance with the second embodiment of the present invention, in which the ultra-fine particle manufacturing apparatus of the fourth embodiment is used to produce the ultra-fine particles;

FIG. 14 is a graph representing the distribution of size of the ultra-fine particles produced by a corona discharge in the ultra-fine particle manufacturing apparatus in accordance with the fourth embodiment of the present invention;

FIG. 15 is a cross-sectional view showing an ultra-fine particle manufacturing apparatus in accordance with the fifth embodiment of the present invention; and

FIG. 16 is a cross-sectional view showing an ultra-fine particle manufacturing apparatus in accordance with the sixth embodiment of the present invention.

### BEST MODE FOR CARRYING OUT THE INVENTION

Hereinafter, preferred embodiments of the present invention will be described in detail with reference to the accompanying drawings.

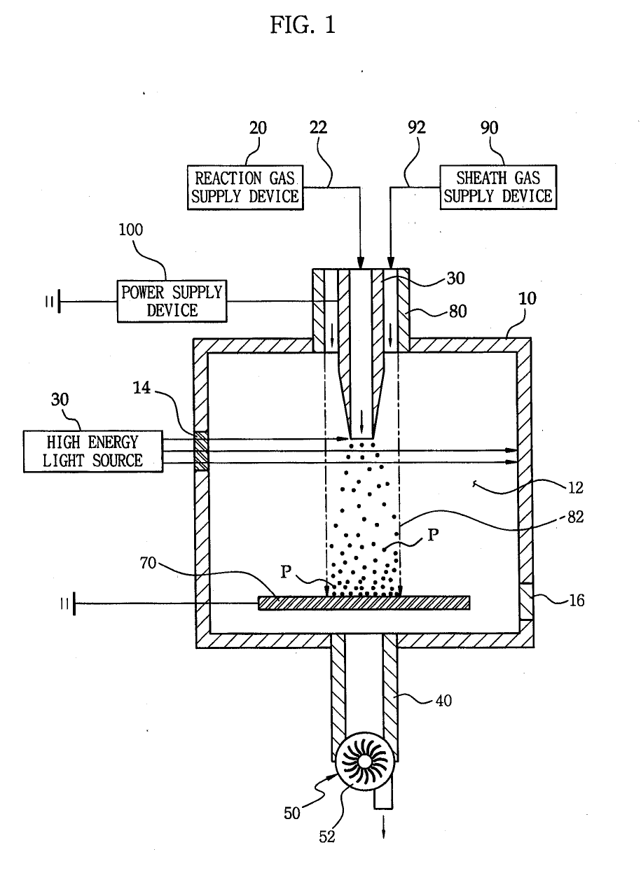

FIG. 1 shows an ultra-fine particle manufacturing apparatus in accordance with the first embodiment of the present invention. Referring to FIG. 1, the ultra-fine particle manufacturing apparatus includes a housing 10 having a chamber 12 in which ultra-fine particles are produced. An optical window 14 is formed on the housing 10 at one side of the chamber 12.

Provided outside the housing 10 is a reaction gas supply device 20 for supplying to the chamber 12 a variety of reaction gases composed of precursors of TTIP (titanium tetraisoproxide, Ti(OC₃H₇)₄), TEOS (tetraethoxyorthosilicate, Si(OCH₂(H₃)₄) and the like. The reaction gas supply device 20 includes a reaction gas source containing the reaction gases, a compressor connected to the reaction gas source for pressurizing the reaction gases and a mass flow controller (MFC) for controlling flow rate of the reaction gases. The reaction gas source is comprised of a reservoir for storing the precursors, a nozzle for injecting the precursors supplied from the reservoir and a heater for heating the precursors as they are injected from the nozzle. The details of the compressor, the mass flow controller, the reservoir, the nozzle and the heater are well-known in the art and therefore will not be described herein. The reaction gases may be supplied by mixing with carrier gases, such as Ar, N₂, He and so forth, stored in a reservoir of a carrier gas source.

On the upstream side of the housing 10, there is disposed a reaction gas inlet tube 30 that remains in communication with the reaction gas supply device 20 through a pipeline 22. The reaction gas inlet tube 30 has a tip end protruding into the chamber 12 such that the reaction gases can be guided toward and injected into the upstream part of the chamber 12. The reaction gas inlet tube 30 has a cross-section of varying shapes, e.g., a circular shape or a slit shape, and may be constructed from a nozzle or a capillary whose diameter is equal to or smaller than 1 mm. Connected to the downstream side of the housing 10 is a gas outlet tube 40 to which is mounted a gas discharging device 50 for forcibly discharging the non-reacted gases from the chamber 12. The gas discharging device 50 is comprised of a pump 52, i.e., an air blower, for generating a gas suction force. The non-reacted gases discharged by the gas discharging device 50 are fed to a well-known scrubber for treatment via a pipeline connected to the gas discharging device 50.

The ultra-fine particle manufacturing apparatus of the first embodiment further includes a high energy light source 60 for irradiating a high energy light beam on the reaction gases introduced into and flowing within the chamber 12 of the housing 10. The light source 60 is disposed outside the housing 10 and the light beam of the light source 60 is irradiated on the reaction gases flowing within the chamber 12 through the optical window 14 of the housing 10. The high energy light source 60 may be comprised of an X-ray generator, an ultraviolet ray generator, an infrared ray generator, a laser or the like. Irradiation of the high energy light beam causes the reaction gases to react in such a way that a myriad of ultra-fine particles P having a nanometer size can be produced.

At the downstream part of the chamber 12, there is disposed a collecting plate 70, as one example of collector means, for collecting the ultra-fine particles P produced by the irradiation of the light beam. The collecting plate 70 is spaced apart from the bottom of the chamber 12 at a predetermined interval and is grounded. A door 16 is attached to the housing 10 and can be opened to load and unload the collecting plate 70 into and out of the chamber 12. If desired, the door 16 may be replaced by a gate valve. Although FIG. 1 illustrates that the collecting plate 70 is disposed at the downstream part of the chamber 12, it may be possible to dispose the collecting plate 70 on the gas discharging tube 40, if needed. In this case, the door 16 should be relocated to the outer surface of the gas discharging tube 40.

The collecting plate 70 is fabricated from, e.g., a silicon wafer, a glass substrate, a filter or the like. The method of collecting ultra-fine particles with the silicon wafer may be employed in manufacturing semiconductors, whereas the method of collecting ultra-fine particles with the glass substrate may find its application in the process of manufacturing flat panel displays such as a TFT-LCD (thin film transistor-liquid crystal display), PDP (plasma display panel) and so forth.

On the upstream end of the housing 10, there is provided a sheath gas inlet tube 80 that encloses the periphery of the reaction gas inlet tube 30 and injects into the housing 10 sheath gases such as Ar, N₂ and the like. The sheath gas inlet tube 80 is connected to a sheath gas supply device 90 via a pipeline 92. Just like the reaction gas supply device 20 noted above, the sheath gas supply device 90 is comprised of a reservoir, a compressor and a mass flow controller, all of which are well-known in the art.

The sheath gases introduced into the chamber 12 of the housing 10 through the sheath gas inlet tube 80 serve to form a gas curtain 82 that encloses the reaction gas inlet tube 30 and its bottom space, as illustrated with single-dotted chain lines in FIG. 1, and thus restrains the flowing direction of the ultra-fine particles P. The air curtain 82 formed by the sheath gases is of a laminar flow that can inhibit any flow of the ultra-fine particles P between the inside and the outside of the gas curtain 82. Furthermore, the gas curtain 82 functions to prevent any diffusion of the ultra-fine particles P and make the flow of the ultra-fine particles P laminar such that the ultra-fine particles P can be collected on the collecting plate 70 in a facilitated manner. This inhibits the ultra-fine particles P from adhering to the inner surface of the housing 10 as they flow within the chamber 12 of the housing 10, thereby effectively avoiding any loss of the ultra-fine particles P.

The ultra-fine particle manufacturing apparatus of the first embodiment further includes a power supply device 100 connected to the reaction gas inlet tube 30 for applying electric voltage to the reaction gas inlet tube 30. The reason for applying the electric voltage is to ensure that the ultra-fine particles P are collected with an increased efficiency by the voltage difference between the reaction gas inlet tube 30 and the collecting plate 70.

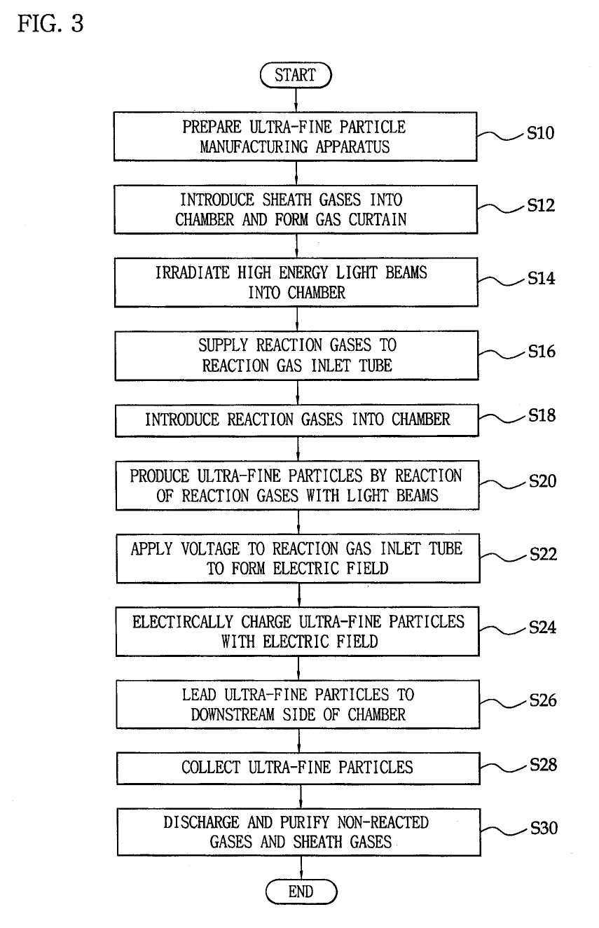

Now, an ultra-fine particle manufacturing method according to the first embodiment of the present invention will be described with reference to FIG. 3.

Referring collectively to FIGS. 1 and 3, the first step is to prepare an ultra-fine particle manufacturing apparatus (S10). Then, the sheath gas supply device 90 is operated to inject the sheath gases into the chamber 12 of the housing 10 through the sheath gas inlet tube 80 in such a manner that the sheath gases form a gas curtain within the chamber 12 (S12). This ensures that the sheath gases introduced into the chamber 12 of the housing 10 flow toward the downstream side of the chamber 12 and form a gas curtain 82 extending between the reaction gas inlet tube 30 and the collecting plate 70 as illustrated with single-dotted chain lines in FIG. 1.

The high energy light source 60 is operated to irradiate high energy light beams into the chamber 12 of the housing 10 (S14). The reaction gas supply device 20 is also operated to feed the reaction gases to the reaction gas inlet tube 30 (S16). Thus, the reaction gases are introduced into the chamber 12 of the housing 10 from the reaction gas inlet tube 30 (S18). The reaction gases introduced into the chamber 12 of the housing 10 react with the high energy light beams, thus producing a myriad of ultra-fine particles P of a nanometer size (S20). In this regard, the high energy light beams outputted from the high energy light source 60 are irradiated on the reaction gases flowing within the chamber 12 through the optical window 14 of the housing 10. As the high energy light beams are irradiated in this manner, the molecular structures of the reaction gases are changed in such a fashion that the components of the reaction gases with a low vapor pressure are condensed into the nanometer-sized ultra-fine particles P.

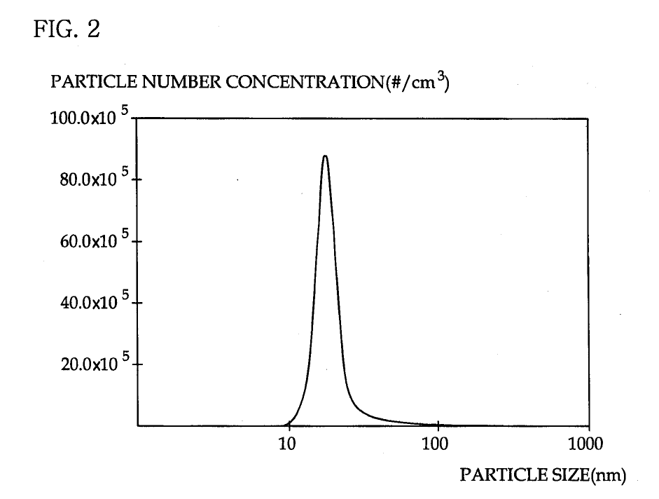

In an effort to examine the size distribution of the ultra-fine particles produced by the ultra-fine particle manufacturing apparatus of the first embodiment, the reaction gases made of a mixture of Fe(CO)₅ and N₂ were introduced into the chamber 12 of the housing 10 and soft X-rays with a wavelength of 1.2-1.5 nm were irradiated on the ultra-fine particles. The size distribution of the ultra-fine particles thus measured is graphically shown in FIG. 2. As is apparent in FIG. 2, the ultra-fine particles have an extremely fine size of about 10 nm, and the geometrical standard deviation σ_{g} is equal to 1.24 when the particles have a diameter D_{P} of 18.75 nm. In this connection, if the geometrical standard deviation σ_{g} is equal to 1, each and every particle will have completely the same size. This means that particles of a substantially equal size can be produced by the ultra-fine particle manufacturing apparatus of the first embodiment.

Subsequently, the power supply device 100 is activated to apply an electric voltage to the reaction gas inlet tube 30 (S22). As the electric voltage is applied to the reaction gas inlet tube 30, an electric field is created between the reaction gas inlet tube 30 and the collecting plate 70 and electrically charges the ultra-fine particles P (S24).

By the operation of the pump 52, the ultra-fine particles P within the chamber 12 are caused to flow toward the gas outlet tube 40 along with the non-reacted gases and the sheath gases (S26), in which process the ultra-fine particles P are collected on the top surface of the collecting plate 70 (S28). At this time, the gas curtain 82 prevents any diffusion of the ultra-fine particles P and helps the ultra-fine particles to flow in a laminar pattern, thus allowing the ultra-fine particles P to be collected on the collecting plate 70 in a facilitated manner. This inhibits the ultra-fine particles P from adhering to the inner surface of the housing 10 as they flow within the chamber 12 of the housing 10, thereby effectively avoiding any loss of the ultra-fine particles P. Moreover, the ultra-fine particles P electrically charged are accelerated within the electric field and rapidly collected on the top surface of the collecting plate 70. Finally, the non-reacted reaction gases and the sheath gases are discharged through the pump 52 to a gas scrubber for purification (S30).

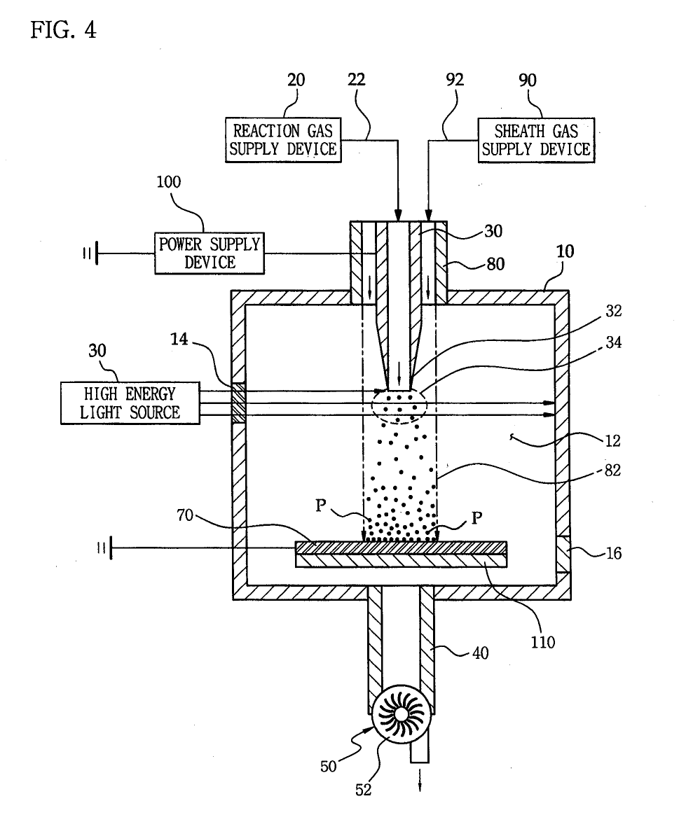

FIG. 4 shows an ultra-fine particle manufacturing apparatus in accordance with the second embodiment of the present invention. Referring to FIG. 4, the ultra-fine particle manufacturing apparatus of the second embodiment includes a housing 10, a reaction gas supply device 20, a reaction gas inlet tube 30, a gas outlet tube 40, a gas discharging device 50, a high energy light source 60, a collecting plate 70, a sheath gas inlet tube 80, a sheath gas supply device 90 and a power supply device 100, all of which are the same as the corresponding components set forth earlier in connection with the first embodiment.

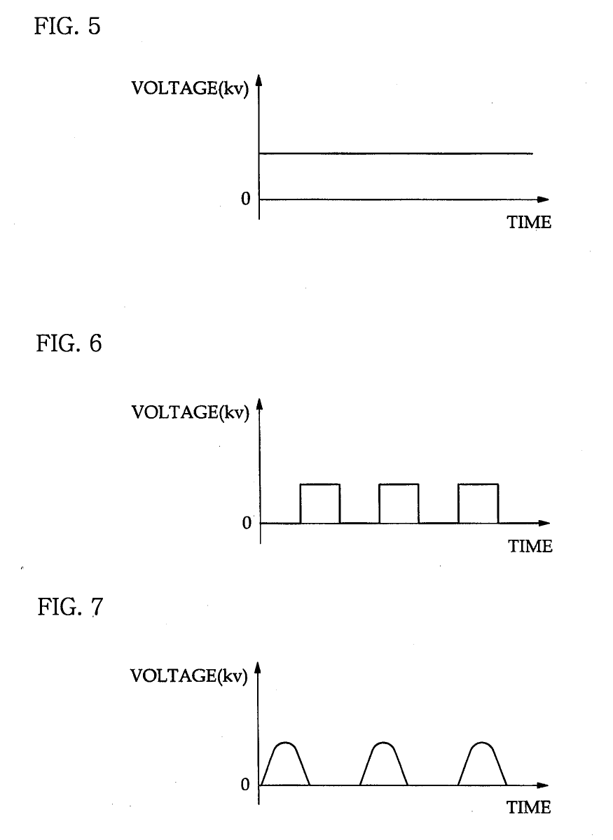

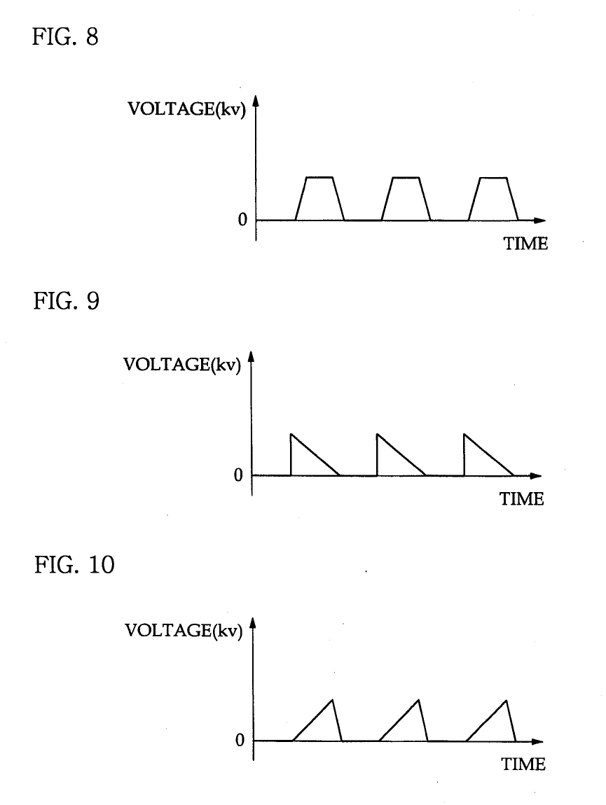

The power supply device 100 is connected to the reaction gas inlet tube 30 so that it can apply a high electric voltage to the latter. The power supply device 100 serves either to apply a direct constant voltage of no smaller than 6 kv to the reaction gas inlet tube 30 as illustrated in FIG. 5 or to apply a pulsating high voltage of no smaller than 6 kv to the reaction gas inlet tube 30 as illustrated in FIGS. 6 through 10. Application of the high voltage by the power supply device 100 causes corona discharge to occur at the tip 32 of the reaction gas inlet tube 30. As depicted with a broken line in FIG. 4, a corona discharge zone is formed by the partial discharge occurring at the tip 32 of the reaction gas inlet tube 30. For example, if the tip 32 has a diameter of no greater than 1 mm, a corona discharge zone 34 of about 1 mm in radius is formed by the partial discharge. A large number of ions and electrons with an increased energy are created in the corona discharge zone 34, which ions and electrons serves to decompose the reaction gases into a myriad of nanometer-sized ultra-fine particles P. Alternatively, as with the ultra-fine particle manufacturing apparatus of the first embodiment, the power supply device 100 employed in the ultra-fine particle manufacturing apparatus of the second embodiment may apply an electric current to the reaction gas inlet tube 30 for the purpose of forming an electric field.

The ultra-fine particle manufacturing apparatus of the second embodiment further includes a cooling device 110 disposed beneath the collecting plate 70. The cooling device 110 acts to increase the ultra-fine particle collecting efficiency by cooling down the collecting plate 70. As the collecting plate 70 is cooled down under the action of the cooling device 110, the ultra-fine particles P flow smoothly from the upstream side to the downstream side of the chamber 12 by the effect of thermophoresis and then collected on the collecting plate 70. The cooling device 110 may be comprised of a coolant-circulating evaporator, a thermoelectric cooler module or other coolers known in the art. Among others, the evaporator is adapted to absorb heat from and cool down the collecting plate 70, which cooling system is useful in the case of requiring a greater cooling capacity. The thermoelectric cooler module acts to cool down the collecting plate 70 by the heat absorption and radiation of a Peltier device, which cooling system is useful in the case of requiring a smaller cooling capacity. It should be appreciated that the cooling device 110 noted above may also be employed with respect to the collecting plate 70 in the ultra-fine particle manufacturing apparatus of the first embodiment.

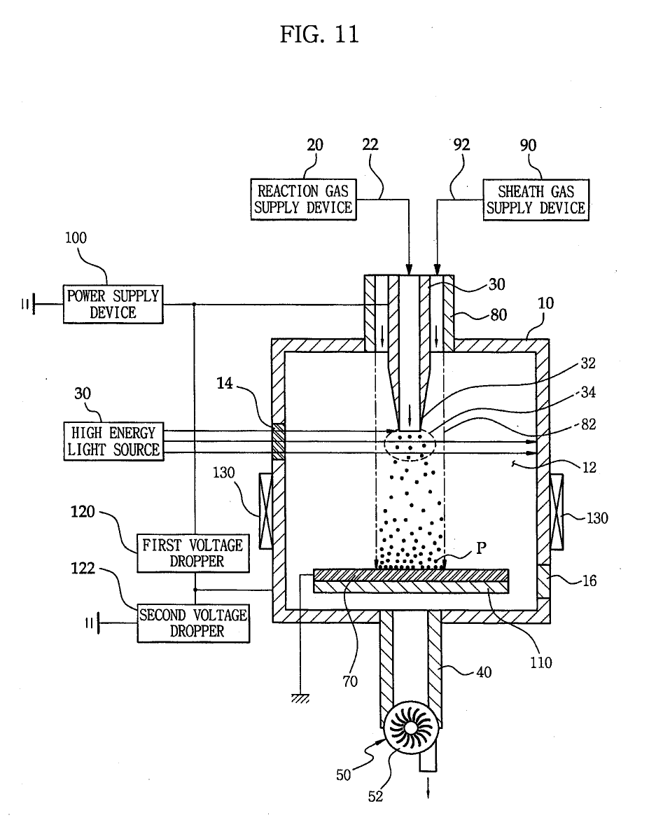

FIG. 11 shows an ultra-fine particle manufacturing apparatus in accordance with the third embodiment of the present invention. Referring to FIG. 11, the ultra-fine particle manufacturing apparatus of the third embodiment includes a housing 10, a reaction gas supply device 20, a reaction gas inlet tube 30, a gas outlet tube 40, a gas discharging device 50, a high energy light source 60, a collecting plate 70, a sheath gas inlet tube 80, a sheath gas supply device 90, a power supply device 100 and a cooling device 110, all of which are the same as the corresponding components set forth above in connection with the second embodiment.

The power supply device 100 is connected to the reaction gas inlet tube 30 so that it can apply a high electric voltage to the latter. Application of the high voltage causes partial corona discharge to occur at the tip 32 of the reaction gas inlet tube 30, thereby creating a corona discharge zone 34. Connected to the power supply device 100 is a first voltage dropper 120 which in turn is coupled to the housing 10. The first voltage dropper 120 serves to reduce the high voltage supplied from the power supply device 100. In response, the housing 10 is supplied with a low voltage whose polarity is the same as that of the high voltage applied to the reaction gas inlet tube 30. Connected to the first voltage dropper 120 is a second voltage dropper 122 that further reduces the voltage already reduced by the first voltage dropper 120. The second voltage dropper 122 is kept grounded. In the case that the first voltage dropper 120 and the second voltage dropper 122 have the same resistance value, the voltage developed between the reaction gas inlet tube 30 and the housing 10 becomes identical to the voltage developed between the housing 10 and the ground.

As the first voltage dropper 120 and the second voltage dropper 122, a variable resistor or a fixed resistor is used capable of developing a voltage difference between the housing 10 and the reaction gas inlet tube 30. Alternatively, two power supply devices each connected to the housing 10 and the reaction gas inlet tube 30 may be employed in place of the power supply device 100, the first voltage dropper 120 and the second voltage dropper 122. In this case, one of the power supply devices serves to apply a high voltage to the reaction gas inlet tube 30 and the other of the power supply devices serves acts to apply a low voltage to the housing 10.

Below the optical window 14 and outside the housing 10, there is provided a heater 130 as a means for imparting thermal energy to the chamber 12. The thermal energy imparted by the heater 130 induces crystal growth of the ultra-fine particles P. The heater 130 may be equally employed in the ultra-fine particle manufacturing apparatuses of the first and second embodiments.

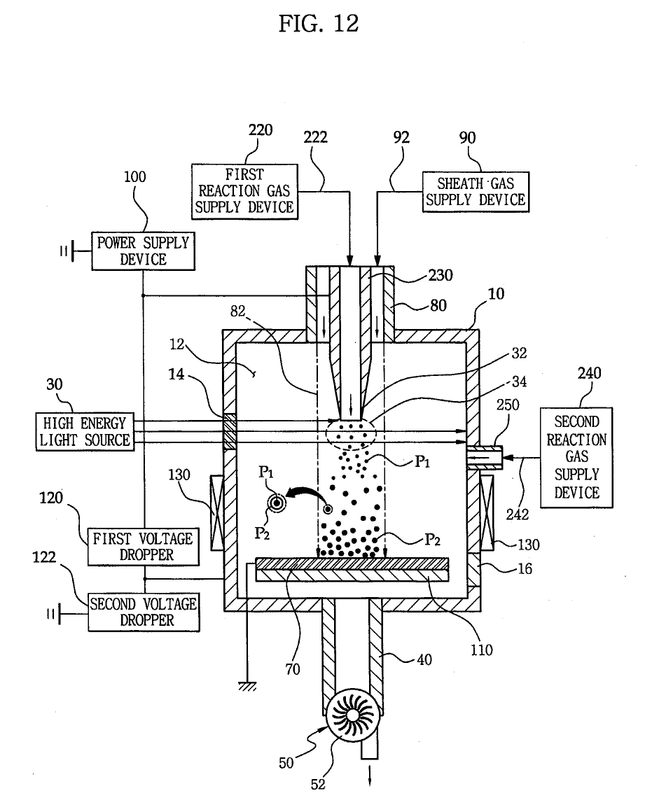

FIG. 12 shows an ultra-fine particle manufacturing apparatus in accordance with the fourth embodiment of the present invention. Referring to FIG. 12, the ultra-fine particle manufacturing apparatus of the fourth embodiment includes a housing 10, a first reaction gas supply device 220, a first reaction gas inlet tube 230, a gas outlet tube 40, a gas discharging device 50, a high energy light source 60, a collecting plate 70, a sheath gas inlet tube 80, a sheath gas supply device 90, a power supply device 100, a cooling device 110, a first voltage dropper 120, a second voltage dropper 122 and a heater 130, all of which are the same as the corresponding components set forth above in connection with the third embodiment.

The first reaction gas inlet tube 230 is connected to the first reaction gas supply device 220 via a pipeline 222. The ultra-fine particle manufacturing apparatus of the fourth embodiment further includes a second reaction gas supply device 240 and a second reaction gas inlet tube 250. The second reaction gas inlet tube 250 is provided at one side of the outer surface of the housing 10 in between the optical window 14 and the heater 130. The second reaction gas inlet tube 250 remains in communication with the second reaction gas supply device 240 via a pipeline 242 so as to introduce therethrough the second reaction gases supplied from the second reaction gas supply device 240 into the chamber 12.

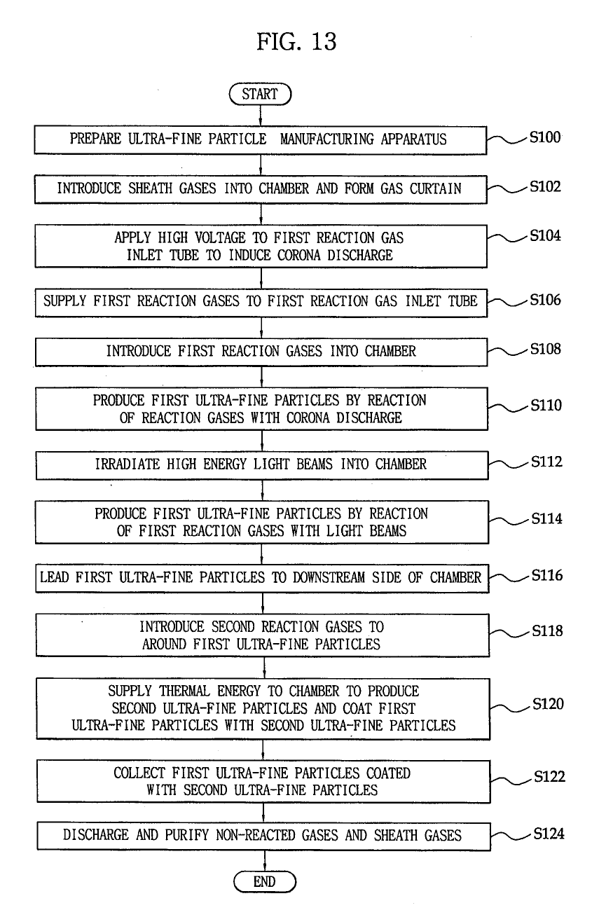

Now, an ultra-fine particle manufacturing method according to the second embodiment of the present invention will be described with reference to FIG. 13. The description will be centered on the operation of the ultra-fine particle manufacturing apparatus of the fourth embodiment, in view of the fact that the apparatuses of the second to fourth embodiments are essentially identical to one another but differ partially in their operation.

Referring collectively to FIGS. 12 and 13, the first step is to prepare the ultra-fine particle manufacturing apparatus of the fourth embodiment (S100). Then, the sheath gas supply device 90 is operated to inject the sheath gases into the chamber 12 of the housing 10 through the sheath gas inlet tube 80 in such a manner that the sheath gases form a gas curtain within the chamber 12 (S102). This ensures that the sheath gases introduced into the chamber 12 of the housing 10 flow toward the downstream side of the chamber 12 and form a gas curtain 82 extending between the ceiling of the housing 10 and the collecting plate 70 to enclose the corona discharge zone 34, as illustrated with single-dotted chain lines in FIG. 12.

The power supply device 100 is operated to apply a high voltage to the first reaction gas inlet tube 230, thereby inducing the corona discharge (S104). The power supply device 100 applies a direct constant voltage of higher intensity to the first reaction gas inlet tube 230, which high voltage is also dropped into a low voltage by the first voltage dropper 120 and then applied to the housing 10. Corona discharge occurs at the tip 232 of the first reaction gas inlet tube 230 by the high voltage supplied from the power supply device 100. The corona discharge creates a corona discharge zone 234 around the tip 232 of the first reaction gas inlet tube 230, as depicted with a broken line in FIG. 12. The corona discharge is induced at the time when the power supply device 100 applies a high voltage of, e.g., 8-10 kv, to the first reaction gas inlet tube 230.

Subsequently, the first reaction gas supply device 220 is operated to supply the first reaction gases composed of, e.g., TEOS, to the first reaction gas inlet tube 230 through the pipeline 222 (S106). The first reaction gases are introduced into the chamber 12 of the housing 10 through the first reaction gas inlet tube 230 (S108). The first reaction gases supplied to the corona discharge zone 34 through the first reaction gas inlet tube 230 are decomposed by the ions and the electrons of high energy into a myriad of first nanometer-sized ultra-fine particles P₁ (S110). At this time, the first reaction gases composed of TEOS is converted to the first ultra-fine particles of SiO₂.

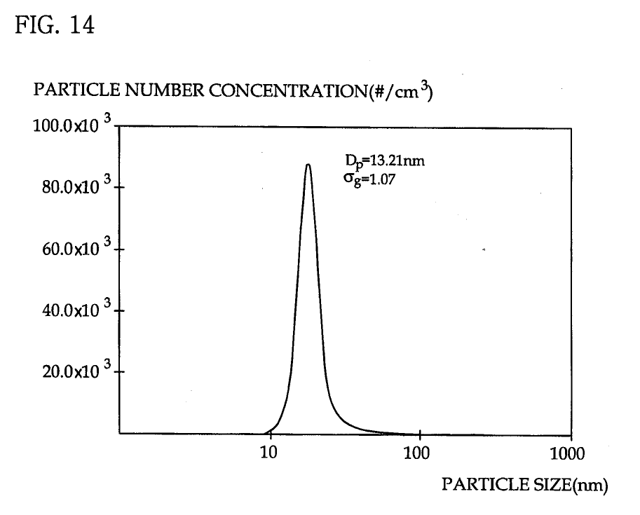

As can be seen in FIG. 14, the first ultra-fine particles P₁ produced by the corona discharge have an extremely fine size of about 10 nm, and the geometrical standard deviation σ_{g} is equal to 1.07 when the particles have a diameter D_{P} of 13.21 nm. In this connection, if the geometrical standard deviation σ_{g} is equal to 1, each and every particle will have completely the same size. This means that particles of a substantially equal size can be produced by the ultra-fine particle manufacturing apparatus of the second embodiment. Furthermore, the first ultra-fine particles P₁ are electrically charged with the same polarity by means of the ions, which assures that there exist electrical repellant forces between the first ultra-fine particles P₁, thus preventing the first ultra-fine particles P₁ from cohering together. As the first ultra-fine particles P₁ leave the corona discharge zone 34, they are maintained at a normal temperature and therefore are not subjected to coalescence which would otherwise take place by the mutual collision of the first ultra-fine particles P₁.

Referring back to FIG. 12, the high energy light source 60 is operated to irradiate the high energy light beams into the chamber 12 of the housing 10 (S112). Thus the first reaction gases are reacted with the light beams to produce a myriad of first nanometer-sized ultra-fine particles P₁ (S114). As the high energy light beams are irradiated in this manner, the molecular structures of the first reaction gases are changed in such a fashion that the components of the reaction gases with a low vapor pressure are condensed into the nanometer-sized ultra-fine particles P₁. If the corona discharge and the irradiation of the high energy light beams are conducted in parallel in this way, the first reaction gases can be converted to the ultra-fine particles with an increased yield rate.

Then, the pump 52 is operated so as to cause the first ultra-fine particles P₁, the non-reacted gases and the sheath gases to flow from the chamber 12 toward the gas outlet tube 40 (S116). The second reaction gas supply device 240 is operated to supply the second reaction gases composed of, e.g., TTIP, to the second reaction gas inlet tube 250 through the pipeline 242. This allows the second reaction gases to be injected from the second reaction gas inlet tube 250 to around the first ultra-fine particles P₁ flowing within the chamber 12 of the housing 10 (S118). The heater 130 is operated to apply thermal energy to the chamber 12 of the housing 10 such that the second reaction gases are subjected to thermal chemical reaction, thus producing second ultra-fine particles P₂. The second ultra-fine particles P₂ that have undergone the thermal chemical reaction are coated on the surface of the first ultra-fine particles P₁ flowing toward the downstream side within the chamber 12 (S120). In this process, the SiO₂ particles produced from the first reaction gases are coated with the TiO₂ particles obtained from the second reaction gases, thereby creating TiO₂-coated SiO₂ particles. At this time, the ultra-fine particles P₁ do not adhere to the housing 10, due to the fact that the housing 10 is applied with the low voltage whose polarity is the same as that of the high voltage applied to the first reaction gas inlet tube 230. Accordingly, it is possible to minimize the loss of the ultra-fine particles P₁ and to collect them with enhanced efficiency.

In the meantime, the first ultra-fine particles P₁ coated with the second ultra-fine particles P₂ are collected on the collecting plate 70 (S122). The collecting plate 70 is cooled down by the operation of the cooling device 110, at which time the first ultra-fine particles P₁ coated with the second ultra-fine particles P₂ flow smoothly from the upstream side to the downstream side of the chamber 12 by the effect of thermophoresis and then collected on the collecting plate 70. Finally, the non-reacted first and second reaction gases and the sheath gases are discharged through the pump 52 to a gas scrubber for purification (S124).

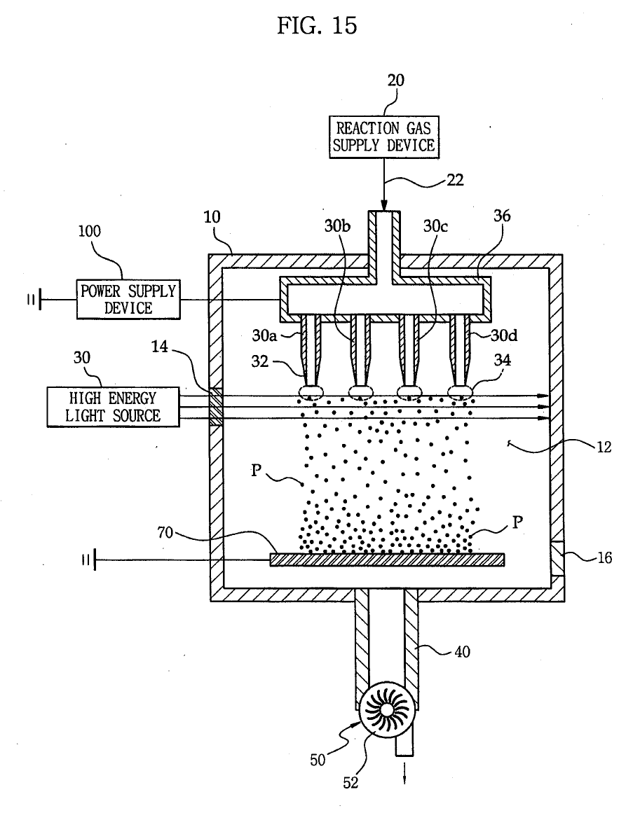

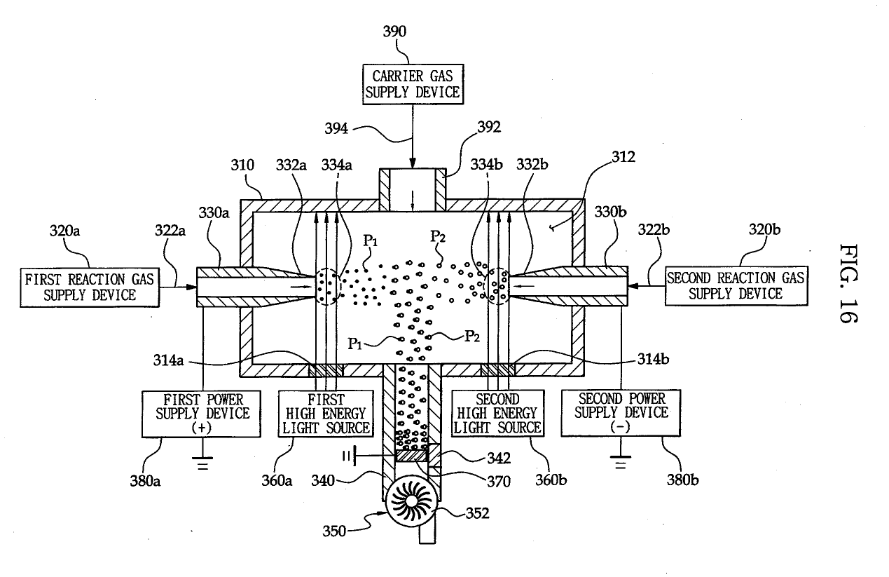

FIG. 15 shows an ultra-fine particle manufacturing apparatus in accordance with the fifth embodiment of the present invention. Referring to FIG. 15, the ultra-fine particle manufacturing apparatus of the fifth embodiment includes four reaction gas inlet tubes 30a-30d integrally connected to a hollow connecting pipe 36 which in turn is connected to the pipeline 22 of the reaction gas supply device 20. The power supply device 100 serves to apply a high voltage to the connecting pipe 36. The collecting plate 70 is grounded and remains spaced apart from the tips 32 of the respective reaction gas inlet tubes 30a-30d. Although four reaction gas inlet tubes are illustrated in FIG. 15, the number of the reaction gas inlet tubes may be lesser or greater, if needed.

According to the ultra-fine particle manufacturing apparatus of the fifth embodiment, if the power supply device 100 applies a high voltage to the connecting pipe 36, corona discharge occurs at the respective tips 32 of the reaction gas inlet tubes 30a-30d, thereby forming a corona discharge zone 34. This produces a greater quantity of ultra-fine particles than in the case of using a single reaction gas inlet tube. The yield rate of the ultra-fine particles is further increased as the reaction gases are uniformly introduced into the chamber 12 of the housing 10 through the reaction gas inlet tubes 30a-30d and irradiated by the light beams emitted from the high energy light source 60. The reaction gas inlet tubes 30a-30d constituting the ultra-fine particle manufacturing apparatus of the fifth embodiment may be employed in the ultra-fine particle manufacturing apparatuses of the first through fourth embodiments.

FIG. 16 shows an ultra-fine particle manufacturing apparatus in accordance with the sixth embodiment of the present invention. Referring to FIG. 16, the ultra-fine particle manufacturing apparatus of the sixth embodiment includes a housing 310, first and second reaction gas supply devices 320a and 320b, first and second reaction gas inlet tubes 330a and 330b, a gas outlet tube 340, a gas discharging device 350, first and second high energy light sources 360a and 360b, a collecting plate 370, and first and second power supply devices 380a and 380b.

The first and second reaction gas inlet tubes 330a and 330b are mounted on one and the other sides of the housing 310 in a mutually confronting relationship and protrude into the chamber 312 of the housing 310 at their tips 332a and 332b. The first reaction gas inlet tube 330a is connected through a pipeline 322a to the first reaction gas supply device 320a that serves to supply first reaction gases to the chamber 312 of the housing 310. The second reaction gas inlet tube 330b is connected through a pipeline 322b to the second reaction gas supply device 320b that serves to supply second reaction gases differing from the first reaction gases to the chamber 312 of the housing 310.

Furthermore, the gas outlet tube 340 is connected to the lower center part of the housing 310 and centrally aligned between the first reaction gas inlet tube 330a and the second reaction gas inlet tube 330b. The gas discharging device 350 has a pump 352 mounted at the downstream end of the gas outlet tube 340. The collecting plate 370 is loaded into and unloaded from the gas outlet tube 340 through a door 342 and remains grounded. First and second optical windows 314a and 314b are respectively provided on the lower opposite sides of the housing 310. Through the first and second optical windows 314a and 314b, the first and second high energy light sources 360a and 360b irradiate high energy light beams on the first and second reaction gases introduced into the chamber 312 of the housing 310.

The first and second power supply devices 380a and 380b are adapted to apply high voltages of opposite polarities to the first reaction gas inlet tube 330a and the second reaction gas inlet tube 330b, respectively, so that corona discharge occurs at the tip 332a of the first reaction gas inlet tube 330a and the tip 332b of the second reaction gas inlet tube 330b. For example, the first power supply device 380a applies a high voltage of a positive polarity to the first reaction gas inlet tube 330a but the second power supply device 380b applies a high voltage of a negative polarity to the second reaction gas inlet tube 330b.

The first and second reaction gas supply devices 320a and 320b serve to supply the first and second reaction gases of different kinds to the first reaction gas inlet tube 330a and the second reaction gas inlet tube 330b through the pipelines 322a and the 322b. The first ultra-fine particles P₁ flowing through the corona discharge zone 334a of the first reaction gas inlet tube 330a are positively charged, while the second ultra-fine particles P₂ flowing through the corona discharge zone 334b of the second reaction gas inlet tube 330b are negatively charged. The positively charged first ultra-fine particles P₁ and the negatively charged second ultra-fine particles P₂ are bonded to each other at the midway area between the first reaction gas inlet tube 330a and the second reaction gas inlet tube 330b. This makes it possible to obtain an ultra-fine particle mixture in which the first ultra-fine particles P₁ are admixed with the second ultra-fine particles P₂ at a predetermined ratio.

One of the first and second reaction gas inlet tubes 330a and 330b, for example, the second reaction gas inlet tube 330b, may be grounded and the second power supply device 380b may be eliminated it its entirety. In this case, if the first power supply device 380a applies a high voltage to the first reaction gas inlet tube 330a, a high potential difference is developed between the first reaction gas inlet tube 330a and the second reaction gas inlet tube 330b such that corona discharge can occur at the tip 332a of the first reaction gas inlet tube 330a and the tip 332b of the second reaction gas inlet tube 330b.

The ultra-fine particle manufacturing apparatus of the sixth embodiment further includes a carrier gas supply device 390 and a carrier gas inlet tube 392. The carrier gas supply device 390 serves to supply carrier gases, such as Ar, N₂, He or the like, to thereby assure smooth flow of the first ultra-fine particles P₁, the second ultra-fine particles P₂ and the mixture thereof. The carrier gas inlet tube 392 is mounted on the top of the housing 310 in an alignment with the gas outlet tube 340 and communicates with the carrier gas supply device 390 through a pipe line 394. The carrier gases are supplied to the carrier gas inlet tube 392 by the operation of the carrier gas supply device 390 and then introduced into the upstream end of the chamber 312. The carrier gases flow downwardly from the upstream side of the chamber 312, thus leading the ultra-fine particle mixture to the gas outlet tube 340. Accordingly, the ultra-fine particle mixture is collected on the top surface of the collecting plate 370 with increased efficiency.

Although a variety of preferred embodiments of the present invention have been described for the illustrative purpose only, it will be apparent to those skilled in the art that the present invention is not restricted to the illustrated embodiments but various changes or modifications may be made thereto within the scope of the invention defined by the appended claims.

### INDUSTRIAL APPLICABILITY

As described in the foregoing, according to the ultra-fine particle manufacturing apparatus and method of the present invention, it is possible to produce, with an increased yield rate and collection efficiency, ultra-fine particles of a nanometer size from varying kinds of reaction gases through irradiation of high energy light beams, corona discharge and formation of electric fields. Also possible is to have different kinds of ultra-fine particles bonded together and to efficiently coat one kind of ultra-fine particles on the other, thereby producing new kinds of ultra-fine particles in an easy and efficient manner.

1. An ultra-fine particle manufacturing apparatus comprising:
a housing having a chamber and an optical window provided at one side of the chamber;
a reaction gas supply means provided outside the housing for supplying reaction gases to the chamber;
at least one reaction gas inlet tube mounted on an upstream side of the housing and connected to the reaction gas supply means for introducing the reaction gases into the chamber;
a gas outlet tube mounted on a downstream side of the housing for discharging non-reacted gases;
a high energy light source provided for irradiating high energy light beams on the reaction gases introduced into the chamber through the optical window of the housing to produce a large quantity of ultra-fine particles;
a collecting means grounded and disposed at a downstream side within the chamber for collecting the ultra-fine particles; and
a power supply means connected to the reaction gas inlet tube for applying a voltage to the reaction gas inlet tube.

2. The ultra-fine particle manufacturing apparatus as recited in claim 1, further comprising a sheath gas inlet tube mounted on the upstream side of the housing in such a manner as to enclose the reaction gas inlet tube and a sheath gas supply means for supplying sheath gases to the sheath gas inlet tube so as to form a gas curtain adapted for guiding the flow of the ultra-fine particles in between the reaction gas inlet tube and the collecting means.

3. The ultra-fine particle manufacturing apparatus as recited in claim 1, wherein the power supply means is adapted to apply the voltage to the reaction gas inlet tube in such a manner that an electric field is formed between the reaction gas inlet tube and the collecting means to electrically charge the ultra-fine particles.

4. The ultra-fine particle manufacturing apparatus as recited in claim 1, wherein the power supply means is adapted to supply the reaction gas inlet tube with a high voltage great enough to induce corona discharge, and further comprising a first voltage dropper for reducing the high voltage supplied from the power supply means into a low voltage and applying the low voltage to the housing and a second voltage dropper grounded and connected to the first voltage dropper.

5. The ultra-fine particle manufacturing apparatus as recited in claim 1, further comprising a cooling device mounted on a bottom surface of the collecting means for cooling down the collecting means.

6. The ultra-fine particle manufacturing apparatus as recited in claim 1, further comprising a heater mounted on an outer surface of the housing for applying thermal energy to between the reaction gas inlet tube and the collecting means.

7. An ultra-fine particle manufacturing apparatus comprising:
a housing having a chamber and an optical window provided at one side of the chamber;
a first reaction gas supply means provided outside the housing for supplying first reaction gases to the chamber;
at least one first reaction gas inlet tube mounted on an upstream side of the housing and connected to the first reaction gas supply means for introducing the first reaction gases into the chamber;
a gas outlet tube mounted on a downstream side of the housing for discharging non-reacted gases;
a high energy light source provided for irradiating high energy light beams on the first reaction gases introduced into the chamber through the optical window of the housing to produce a large quantity of first ultra-fine particles;
a second reaction gas supply means provided outside the housing for supplying second reaction gases differing from the first reaction gases to the chamber;
at least one second reaction gas inlet tube mounted on a middle part of the housing and connected to the second reaction gas supply means for introducing the second reaction gases into the chamber;
a heater provided on an outer surface of the housing for supplying thermal energy such that the second reaction gases are subjected to thermal chemical reaction so as to produce a large quantity of second ultra-fine particles and the first ultra-fine particles are coated with the second ultra-fine particles; and
a collecting means disposed at a downstream side within the chamber for collecting the first ultra-fine particles coated with the second ultra-fine particles.

8. The ultra-fine particle manufacturing apparatus as recited in claim 7, further comprising a sheath gas inlet tube mounted on the upstream side of the housing in such a manner as to enclose the first reaction gas inlet tube and a sheath gas supply means for supplying sheath gases to the sheath gas inlet tube so as to form a gas curtain adapted for guiding the flow of the first ultra-fine particles in between the first reaction gas inlet tube and the collecting means.

9. The ultra-fine particle manufacturing apparatus as recited in claim 7, further comprising a power supply means adapted to supply the first reaction gas inlet tube with a high voltage great enough to induce corona discharge, a first voltage dropper for reducing the high voltage supplied from the power supply means into a low voltage and applying the low voltage to the housing, and a second voltage dropper grounded and connected to the first voltage dropper, wherein the collecting means is kept grounded.

10. The ultra-fine particle manufacturing apparatus as recited in claim 7, further comprising a cooling device mounted on a bottom surface of the collecting means for cooling down the collecting means.

11. An ultra-fine particle manufacturing apparatus comprising:
a housing having a chamber and first and second optical windows provided at opposite sides of the chamber;
a first reaction gas supply means provided outside the housing for supplying first reaction gases to the chamber;
at least one first reaction gas inlet tube mounted on one side of the housing and connected to the first reaction gas supply means for introducing the first reaction gases into the chamber;
a gas outlet tube mounted on a downstream side of the housing for discharging non-reacted gases;
a first high energy light source provided for irradiating high energy light beams on the first reaction gases introduced into the chamber through the first optical window of the housing to produce a large quantity of first ultra-fine particles;
a second reaction gas supply means provided outside the housing for supplying second reaction gases differing from the first reaction gases to the chamber;
at least one second reaction gas inlet tube mounted on the other side of the housing and connected to the second reaction gas supply means for introducing the second reaction gases into the chamber;
a second high energy light source provided for irradiating high energy light beams on the second reaction gases introduced into the chamber through the second optical window of the housing to produce a large quantity of second ultra-fine particles bondable to the first ultra-fine particles; and
a collecting means disposed at a downstream side within the chamber for collecting the second ultra-fine particles bonded to the first ultra-fine particles.

12. The ultra-fine particle manufacturing apparatus as recited in claim 11, further comprising first and second power supply means adapted to supply the first and second reaction gas inlet tubes with high voltages great enough to induce corona discharge.

13. The ultra-fine particle manufacturing apparatus as recited in claim 11, further comprising a carrier gas supply means provided outside the housing for supplying carrier gases to the chamber and a carrier gas inlet tube mounted on one side of the housing and connected to the carrier gas supply means for introducing the carrier gas into the chamber in between the first and second reaction gas inlet tubes.

14. An ultra-fine particle manufacturing method comprising the steps of:
irradiating high energy light beams into a chamber of a housing through the use of a high energy light source;
supplying reaction gases from a reaction gas supply means to a reaction gas inlet tube;
introducing the reaction gases through the reaction gas inlet tube into the chamber of the housing to produce a large quantity of ultra-fine particles through the reaction of the reaction gases with the high energy light beams;
applying a voltage to the reaction gas inlet tube by means of a power supply means; and
collecting the ultra-fine particles flowing within the chamber of the housing by means of a collecting means.

15. The ultra-fine particle manufacturing method as recited in claim 14, further comprising the step of supplying sheath gases to form a gas curtain adapted for guiding the flow of the ultra-fine particles in between the reaction gas inlet tube and the collecting means.

16. The ultra-fine particle manufacturing method as recited in claim 14, further comprising the step of cooling down the collecting means by means of a cooling device.

17. The ultra-fine particle manufacturing method as recited in claim 14, further comprising the steps of: supplying different reaction gases distinguished from the above reaction gases to around the ultra-fine particles flowing from the reaction gas inlet tube toward the collecting means; supplying thermal energy to the different reaction gases to produce a large quantity of different ultra-fine particles through a thermal chemical reaction; and coating the ultra-fine particles with the different ultra-fine particles.

18. The ultra-fine particle manufacturing method as recited in claim 14, wherein the step of applying a voltage to the reaction gas inlet tube by means of a power supply means comprises applying the voltage in such a manner that an electric field is formed between the reaction gas inlet tube and the collecting means to electrically charge the ultra-fine particles.

19. The ultra-fine particle manufacturing method as recited in claim 14, wherein the step of applying a voltage to the reaction gas inlet tube by means of a power supply means comprises applying the voltage in such a manner that corona discharge occurs at the reaction gas inlet tube.

20. An ultra-fine particle manufacturing method comprising the steps of:
irradiating high energy light beams into a chamber of a housing through the use of a first high energy light source;
supplying first reaction gases from a first reaction gas supply means to a first reaction gas inlet tube;
introducing the first reaction gases through the first reaction gas inlet tube into the chamber of the housing to produce a large quantity of first ultra-fine particles through the reaction of the first reaction gases with the high energy light beams;
irradiating high energy light beams into the chamber of the housing through the use of a second high energy light source;
supplying second reaction gases from a second reaction gas supply means to a second reaction gas inlet tube;
introducing the second reaction gases through the second reaction gas inlet tube into the chamber of the housing to produce a large quantity of second ultra-fine particles through the reaction of the second reaction gases with the high energy light beams;
allowing the second ultra-fine particles to be bonded to the first ultra-fine particles; and
collecting the second ultra-fine particles bonded to the first ultra-fine particles by means of a collecting means.

21. The ultra-fine particle manufacturing method as recited in claim 20, further comprising the step of introducing carrier gases into the chamber of the housing to lead the second ultra-fine particles bonded to the first ultra-fine particles to the collecting means.

22. The ultra-fine particle manufacturing method as recited in claim 21, further comprising the step of applying high voltages of different polarities to the first reaction gas inlet tube and the second reaction gas inlet tube by means of first and second power supply means so as to induce corona discharge.
